(19) United States
(12) Patent Application Publication
(10) Pub. No.: US 2024/0409372 A1
(43) Pub. Date: Dec. 12, 2024

(54) ELEVATOR LANDING DOOR FRAME AND METHOD OF PROVIDING AN OPENING PORTION OF AN ENTRANCE OF AN ELEVATOR WITH SUCH DOOR FRAME

(71) Applicant: Kone Corporation, Helsinki (FI)

(72) Inventors: Tony YAU, Helsinki (FI); Pekka HOKKANEN, Helsinki (FI); Jukka KORPIHETE, Helsinki (FI); Visa RAUTA, Helsinki (FI); Jouni RATIA, Helsinki (FI); llkka OTSALA, Helsinki (FI); Juho LEPISTÖ, Helsinki (FI); Kai M HELMINEN, Helsinki (FI)

(73) Assignee: Kone Corporation, Helsinki (FI)

(21) Appl. No.: 18/811,279

(22) Filed: Aug. 21, 2024

Related U.S. Application Data
(63) Continuation of application No. PCT/EP2022/057722, filed on Mar. 24, 2022.

(51) Int. Cl. B66B 13/30; E06B 3/12

(52) U.S. Cl. CPC B66B 13/306; E06B 3/12

(57) ABSTRACT

A door frame and a method for providing an elevator with a door frame. The door frame is a three-sided structure installed in an opening portion of an entrance of the elevator. The door frame comprises two opposite upright frame parts and an upper frame part disposed between upper end portions of the upright frame parts. The upright frame parts and the upper frame part each comprise at least one mounting frame element and at least one separate surface element attachable removably to the mounting frame.

### CROSS-REFERENCE TO RELATED APPLICATION

This application is a continuation of PCT International Application No. PCT/EP2022/057722 which has an International filing date of Mar. 24, 2022, the entire contents of which are incorporated herein by reference.

### BACKGROUND OF THE INVENTION

The invention relates to a door frame of an entrance of an elevator.

The invention further relates to a method for providing an entrance opening of an elevator with a door frame.

The field of the invention is defined more specifically in the preambles of the independent claims.

An elevator comprises an elevator car which is moved vertically in an elevator shaft and is stopped at landings. The elevator comprises at the landings entrance openings which typically need to be provided with door frames. However, the known door frame solutions have shown to contain some disadvantages.

### BRIEF DESCRIPTION OF THE INVENTION

An object of the invention is to provide a novel and door frame and a method for an elevator with a door frame.

The door frame according to the invention is characterized by the characterizing features of the first independent apparatus claim.

The method according to the invention is characterized by the characterizing features of the independent method claim.

An idea of the disclosed solution is that the door frame of the elevator is a three-sided structure installable in an opening portion of an entrance of the elevator. A basic structure of the door frame has a gate-like configuration comprising two opposite upright frame parts covering both side portions of the opening portion and an upper frame part disposed between upper end portions of the upright frame parts for covering an upper portion of the opening portion. The upright frame parts and the upper frame part each comprise one or more mounting frame elements and one or more separate surface elements attachable removably to the mounting frame. In other words, the door frame has a multipart structure with removably mounted surface elements, panels, or components.

An advantage of the disclosed solution is that mounting of the door frame is facilitated when separate mounting frame elements are used. The removably mounted surface elements provide several possibilities to update to door frame and they also facilitate service operations.

According to an embodiment, the mounting frame elements comprise fastening means for fixed mounting to a fixed structure surrounding the door frame. The fastening means may comprise fastening openings trough which fastening screws can be mounted.

According to an embodiment, between the surface elements and the mounting frame elements are shape locking elements for providing the surface elements with the removable mounting. In other words, the locking may be done without any separate locking members and without special tools.

According to an embodiment, the surface elements are locked to the mounting frame element by means of quick coupling means. Then, the locking of the surface elements may be based on different snap-in elements, spring elements, bending or elasticity of materials, hooks, or other similar components and arrangements.

According to an embodiment, the surface elements are locked to the mounting frame element by means of hanging mounting or suspension mounting elements or surfaces.

According to an embodiment, the quick coupling system may comprise coupling hooks on inner surfaces of the surface elements and coupling openings may be provided on the mounting frame elements. The hooks may be dimensioned so that longitudinal adjustment movement of the surface panels is possible whereby mounting of the surface panels is facilitated and the surface panels can face neatly at corners of the door frame.

According to an embodiment, the surface elements are provided with tool-free mounting.

According to an embodiment, the surface elements are provided with mounting elements invisible outside the door frame. In other words, the mounting elements are covered by the surface elements. This way, esthetically neat appearance is provided for the door frame structure.

According to an embodiment, the surface elements are one piece elements whereby each of them is covering either the side portion or the upper portion entirely. In other words, the surface elements may extend uniformly from edge to edge in the upright direction, or in the horizontal direction.

According to an embodiment, at least one of the surface elements comprises at least two surface element components which together cover the corresponding mounting frame element. In other words, the surface element consists of several components, panels, or pieces which together form a covering surface on the mounting frame element.

According to an embodiment, the surface element comprises at least two longitudinal surface element components arranged parallel side to side so that width of the surface element is a sum of widths of the several independent surface element components.

According to an embodiment, the surface element comprises at least two surface element components arranged consecutively in longitudinal direction. Thus, there may be two, three or even more surface element components one after each other, and length of the surface element components may be similar, or there may be surface element components with different lengths.

According to an embodiment, at least one surface element comprises at least two surface element components which differ from each other. Thus, there is a possibility to apply different combinations for providing desired appearances and features.

According to an embodiment, at least one of the upright and upper frame parts has a box-like structure comprising free space between inner surfaces of the mounting frame element and the surface element. In other words, the door frame structure is provided with free spaces wherein the surface elements serve as a kind of openable and closable covers or lids. An advantage of the disclosed embodiment is that the free spaces may be equipped with need electrical, mechanical, and acoustic installations and components. Inside free the space, the included installations are sheltered, and they may, or may not, be invisible outside the door frame.

According to an embodiment, the free space may comprise electrical cables, electrical apparatuses, illuminating devices, loudspeakers and sensing devices, for example.

According to an embodiment, at least one of the changeable surface elements is a decorative panel. In other words, the door frame structure is provided with one or more decorative panels provided with desired esthetical features for providing the door frame with attractive appearance and for improving user experience. An advantage of the disclosed embodiment is that the separate decorative panels allow an easy and handy way to provide the door frame with different appearances. Further, the appearance of the door frame to be updated later just by changing suitable decorative panels on the mounting frames.

According to an embodiment, the decorative surface element may comprise at least one of the following features relating to its material and decorative properties:
transparent material at or least partly transparent allowing light to penetrate through it,
use of different materials such as stainless steel, aluminum, wood, fiber materials, plastic, composites, and combinations of different materials,
use of different coatings on the surface panels,
use of different surface roughness's on the surface panels, such as polished surfaces, scratched surfaces, patterned surfaces,
use of different surface decorations, colors, patterns,
use of different punctures, openings on the surface of the surface component,
use of 3D surface configuration wherein the surface comprises desired topography,
the surface panel may be made at least partly by means of additive manufacturing technology (AM), such as 3D printing.

According to an embodiment, the mounting frame element may be made of steel material by using metal sheet working techniques, such as cutting, bending, and punching. It is also possible to implement other metal materials, such as aluminum. Mounting frame may also be manufacture from plastic materials, or composite materials.

According to an embodiment, at least one of the changeable surface elements is a functional panel provided with at least one controllable feature. In other words, the door frame structure is provided with the functional surface elements provided with integrated devices or systems. The devices and systems may be controlled by processors or electronic devices of the elevator, or other systems.

According to an embodiment, the integrated electrical devices or systems of the functional panels may be controlled from an external control device, controller, power unit, server, or electrical terminal device, for example.

According to an embodiment, one or more electronic devices are integrated to be part of the functional surface element.

According to an embodiment, the functional surface element comprises at least one of the following devices or systems:
signaling device, indicating device, call giving device,
sensing device, measuring device, detector,
control panel, selection button,
user interface, display device,
sound generator, loudspeaker,
data communicating device,
illuminating device, light string, led units, lightning system,
access control system.

According to an embodiment, at least one of the mentioned surface elements and mounting frame elements comprises at least one pre-mounted electrical cable and at least one pre-mounted electrical coupling component. In other words, the elements of the door frame i.e., the surface elements and mounting frame elements are provided with factory installed electrical cables and connectors, or connecting terminals, whereby there is no need to make time consuming electrical installations at the construction site. Further, the electrical installations and systems can be tested at the manufacturing site, whereby difficulties at the construction or installation site can be avoided. Thus, proved systems are delivered to the construction site.

According to an embodiment, the disclosed solution relates to a method of providing an entrance opening of an elevator with a door frame. The method comprises: providing the door frame with two opposite upright frame parts and mounting them to opposite side portions of the opening portion; and providing the door frame also with an upper frame part and disposing the upper frame part between upper end portions of the upright frame parts and thereby covering an upper portion of the opening portion. The method further comprises providing the upright frame parts and the upper frame part each with at least one mounting frame element and at least one separate surface element; mounting the mounting frame parts fixedly against surfaces of walls limiting the opening portion of the entrance of the elevator; and mounting the surface element removably to the mounting frame.

According to an embodiment, the method comprises using pre-cut mounting frame elements lengths of which are dimensioned in accordance with dimensions of the opening portion of the entrance of the elevator.

According to an embodiment, the method comprises assembling the mounting frame parts together at the installation site for forming a pre-assembled mounting frame structure; and mounting the mounting frame structure in one piece to the wall surfaces.

According to an embodiment, the method comprises preassembling the mounting frame structure outside the opening part. The preassembly can be done in horizontal position after which the frame can be lifter up and pushed to the door opening part.

According to an embodiment, the method comprises using temporary angle fasteners at upper corners of the mounting frame structure and supporting lower ends of the upright frame parts by means of temporary transverse support, such as a beam made of sheet metal. The mounting frame structure being assembled by means of the mentioned temporary support element can be easily moved and its correct position at the opening portion can be adjusted before actual fastening measures. After the mounting frame structure is fastened firmly to the surrounding walls by means screws or other fasteners, the temporary support elements are removed.

According to an embodiment, the method comprises delivering a complete installation set to the installation site, wherein the installation set comprise precut mounting frame elements, surface elements, and installation aids.

According to an embodiment, the method comprises hanging the surface elements to the mounting frame elements by means of shape locking elements.

According to an embodiment, the method comprises mounting the surface elements without any outside visible fastening elements.

According to an embodiment, the method comprises providing the door frame with decorative surface panels.

According to an embodiment, the method comprises providing the door frame with functional surface panels.

The above disclosed embodiments may be combined in order to form suitable solutions having those of the above features that are needed.

### BRIEF DESCRIPTION OF THE FIGURES

Some embodiments are described in more detail in the accompanying drawings, in which

FIG. 1 is a schematic and highly simplified side view of an elevator,

FIG. 2 is a schematic diagram of some features of a door frame of an elevator,

FIG. 3 is a schematic front view of a door opening entrance of an elevator,

FIG. 4 is a schematic axonometric view of a door opening entrance and wall structure of a building,

FIG. 5 is a schematic axonometric view of a mounting frame structure in an assembled state,

FIG. 6 is a schematic detailed view of a corner of a mounting frame structure and installation aids used therein,

FIGS. 7-9 are schematic axonometric views showing installation of surface elements on an assembled mounting frame structure,

FIG. 10 is a schematic diagram of some features relating to decorative surface elements, and

FIG. 11 is a schematic diagram of some features relating to functional surface elements.

For the sake of clarity, the figures show some embodiments of the disclosed solution in a simplified manner. In the figures, like reference numerals identify like elements.

### DETAILED DESCRIPTION OF SOME EMBODIMENTS

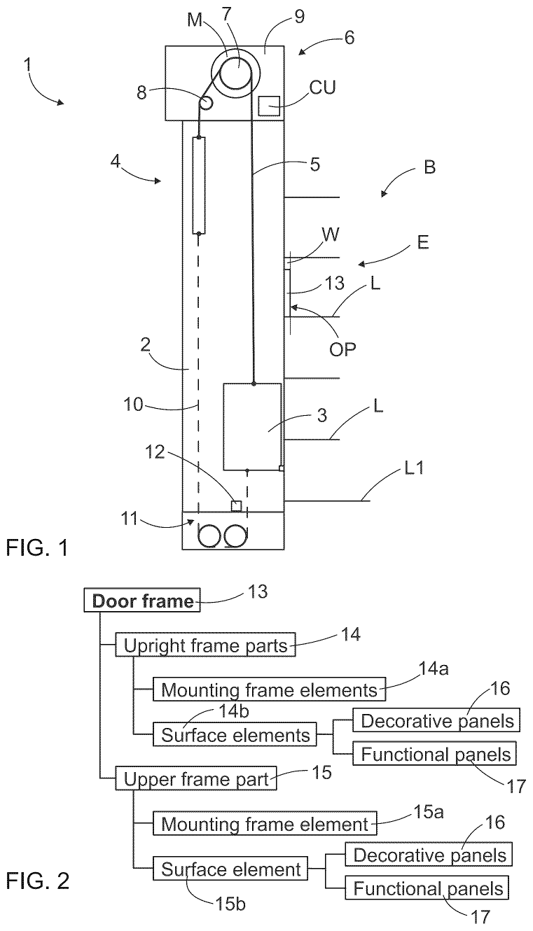

FIG. 1 discloses a traction elevator 1 mounted to an elevator shaft 2 of a building B. The elevator 1 comprises an elevator car 3 for receiving load to be transported. The car 3 and a counterweight assembly 4 are suspended from a suspension rope 5 passing via a hoisting machinery 6. The hoisting machinery 6 comprises a traction sheave 7 driven by means of an electric motor M. Between the suspension rope 5 and the traction sheave 7 occurs friction which is utilized for transmitting lifting power to the elevator system. The hoisting machinery 6 may comprise one or more additional pulleys 8 for guiding and controlling the suspension rope 5. The hoisting machinery 6 may be located at an upper machine room 9, or alternatively the system may be a so called machine room less elevator. A compensation chain or rope 10 may be connected between the counterweight assembly 4 and a bottom of the elevator car 3. The elevator car 3 can be driven to desired landings L or floors under control of one or more control units CU. Below a first or lowermost landing there may be a pit 11 of an elevator shaft 2. There may be buffers 12 in the elevator shaft below the first landing L1.

Further, at the landings L there are entrances E provided with opening portions OP formed to wall structures W of the building B. The opening portions OP are provided with door frames 13. The door frames 13 are in accordance with the features and embodiments disclosed in this document.

FIG. 2 discloses that a door frame 13 comprises upright frame parts 14 and upper frame parts 15. The door frame 13 is a three-sided structure installable in an opening portion of an entrance of the elevator whereby the door frame has a gate-like configuration comprising two opposite upright frame parts 14 covering both side portions of the opening portion OP and one upper frame part 15 disposed between upper end portions of the upright frame parts 14 for covering an upper portion of the opening portion OP. The upright frame parts 14 comprise mounting frame elements 14a and separate surface element 14b attachable removably to the mounting frame elements 14a. Correspondingly, the upper frame part 15 comprises a mounting frame element 15a and a separate surface element 15b attachable removably to the mounting frame element 15a. FIG. 2 further discloses that the surface elements 14b, 15b may be decorative panels 16 or functional panels 17.

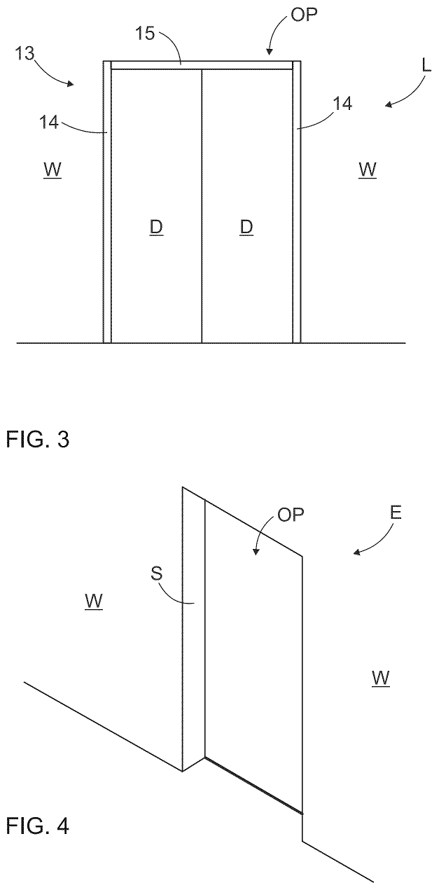

FIG. 3 discloses a face of a door frame 13 seen from an elevator lobby L. The door frame is mounted to an opening portion OP of a wall structure W and comprises upright frame parts 14 and an upper frame part 15 arranged between their upper end portions. Doors D of the elevator are also shown.

FIG. 4 discloses an opening portion OP of an entrance E. Surfaces S of the opening portion OP may comprise roughness and other esthetical faults as well as dimensional variances which all can be solved by means of the door frame disclosed in this document.

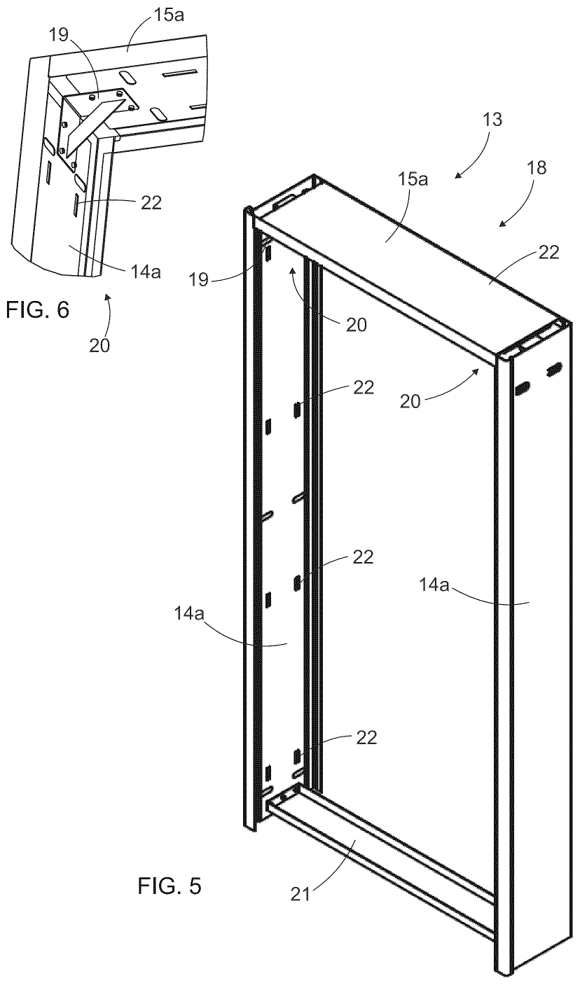

FIG. 5 discloses an assembled structure of a mounting frame 18 of a door frame 13. The structure can be assembled before installing it to a door opening. The assembly of the structure can be facilitated by using angular elements 19 at corners 20 between mounting frame elements 14a, 15a. Between lower end portion of the mounting frame elements 14a may be a transverse installation support 21 which is removed together with the angular elements 19 after the complete mounting frame 18 is fastened to the door opening by means of screws or other fastening elements. FIG. 6 is a detailed view of the corner 20 provided with the temporary angular element 19.

FIGS. 5 and 6 further show that the mounting frame elements 14a, 15a may comprise openings 22 or other forms for providing shape locking surfaces for surface panel elements mountable on the mounting frame element 14a, 15a.

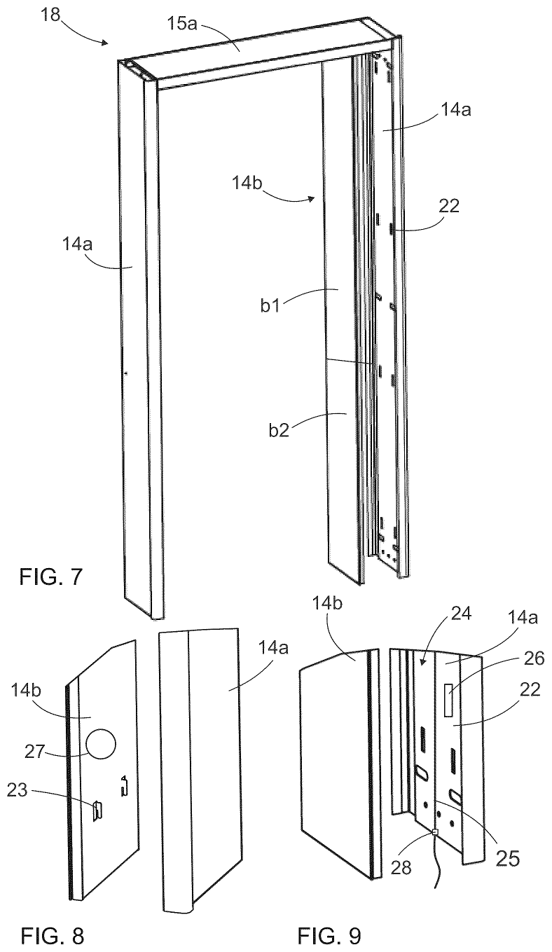

FIG. 7 discloses mounting step of a surface element 14b to a mounting frame element 14a of a mounting frame 18 installed to a door opening. Detailed FIGS. 8 and 9 disclose that the surface element 14b may comprise hooks 23 for forming shape locking with openings 22. When the surface panel 14b is mounted on the mounting frame element 14a a free space 24 may be formed between them. Inside the free space may be electrical cables 25, coupling components 28, and first installations 26. Further, the surface panel 14b may comprise second installations 27. The installations 26, 27 may be electrical devices, for example.

Further, it may be possible to arrange protrusions on the mounting frame elements and openings to surface panel elements.

FIG. 7 further discloses that the surface element 14b may comprise two or more components b1, b2. In Figure the components are one after each other but they may also be side to side. The same structural possibility is suitable also for other surface elements of the door frame.

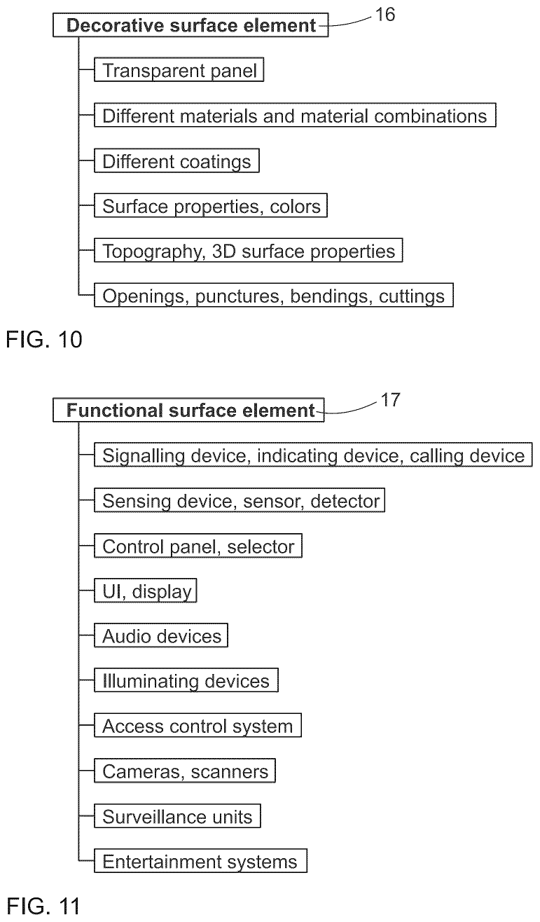

FIGS. 10 and 11 disclose some possible features and devices which different decorative surface element 16 and functional surface elements 17 can offer.

Implementation of the disclosed solution is not limited to the exemplary elevator disclosed in FIG. 1. Further, the disclosed solution may implement also other mounting principles between the mounting frame elements and surface elements. There may screw mountings, quick coupling elements and pop-in fasteners, for example.

The drawings and the related description are only intended to illustrate the idea of the invention. In its details, the invention may vary within the scope of the claims.

The invention claimed is:

1. A door frame of an elevator,
wherein the door frame is a three-sided structure installable in an opening portion of an entrance of the elevator whereby the door frame has a gate-like configuration comprising two opposite upright frame parts covering both side portions of the opening portion and an upper frame part disposed between upper end portions of the upright frame parts for covering an upper portion of the opening portion;
wherein
the upright frame parts and the upper frame part each comprise at least one mounting frame element and at least one separate surface element attachable removably to the mounting frame elements.

2. The door frame as claimed in claim 1, wherein
between the surface elements and the mounting frame elements are shape locking elements for providing the surface elements with the removable mounting.

3. The door frame as claimed in claim 1, wherein
the surface elements are one piece elements whereby each of them is covering either the side portion or the upper portion entirely.

4. The door frame as claimed in claim 1, wherein
at least one of the surface elements comprises at least two surface element components which together cover the corresponding mounting frame element.

5. The door frame as claimed in claim 1, wherein
at least one of the upright and upper frame parts has a box-like structure comprising free space between inner surfaces of the mounting frame element and the surface element.

6. The door frame as claimed in claim 1, wherein
at least one of the changeable surface elements is a decorative panel.

7. The door frame as claimed in claim 1, wherein
at least one of the changeable surface elements is a functional panel provided with at least one controllable feature.

8. The door frame as claimed in claim 1, wherein
at least one of the mentioned surface elements and mounting frame elements comprises at least one pre-mounted electrical cable and at least one pre-mounted electrical coupling component.

9. A method of providing an opening portion of an entrance of an elevator with a door frame;
the method comprising:
providing the door frame with two opposite upright frame parts and mounting them to opposite side portions of the opening portion; and
providing the door frame also with an upper frame part and disposing the upper frame part between upper end portions of the upright frame parts and thereby covering an upper portion of the opening portion;
characterized by
providing the upright frame parts and the upper frame part each with at least one mounting frame element and at least one separate surface element;
mounting the mounting frame elements fixedly against surfaces of walls limiting the opening portion of the entrance of the elevator; and
mounting the surface element removably to the mounting frame element.

10. The method as claimed in claim 9, characterized by
using pre-cut mounting frame elements lengths of which are dimensioned in accordance with dimensions of the opening portion of the entrance of the elevator.

11. The method as claimed in claim 9, characterized by
assembling the mounting frame parts together at the installation site for forming a pre-assembled mounting frame structure; and
mounting the mounting frame structure in one piece to the wall surfaces.

12. The method as claimed in claim 9, characterized by
preassembling a mounting frame structure outside the opening part prior installing to the door opening part.

13. The method as claimed in claim 9, characterized by
hanging the surface elements to the mounting frame elements by means of shape locking elements.

14. The method as claimed in claim 9, characterized by
providing the door frame with decorative surface panels.

15. The method as claimed in claim 9, characterized by
providing the door frame with functional surface panels provided with at least one electrical installation.
